(19) United States
(12) Patent Application Publication
(10) Pub. No.: US 2007/0141405 A1
(43) Pub. Date: Jun. 21, 2007

(54) METHOD OF MAKING A MEMBRANE ELECTRODE ASSEMBLY COMPRISING A VAPOR BARRIER LAYER, A GAS DIFFUSION LAYER, OR BOTH

(75) Inventors: Yeh-Hung Lai, Webster, NY (US); Po-Ya Abel Chuang, Victor, NY (US); Sitima R. Fowler, Fairport, NY (US); Balsu Lakshmanan, Rochester, NY (US); Daniel P. Miller, Victor, NY (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: General Motors Corporation, Detroit, MI (US)

(21) Appl. No.: 11/560,454

(22) Filed: Nov. 16, 2006

Related U.S. Application Data
(60) Provisional application No. 60/737,261, filed on Nov. 16, 2005.

(51) Int. Cl. H01M 8/00

(52) U.S. Cl. 429/12

(57) ABSTRACT

Methods of producing an electrochemical conversion assembly comprising an electrochemical conversion cell are provided. The electrochemical conversion cells which comprises a membrane electrode assembly, first and second flowfield portions defined on opposite sides of the membrane electrode assembly, and, at least one vapor barrier layer disposed between the membrane electrode assembly and at least one of the flowfield portions. The method further includes selecting a desired mass transfer coefficient MTC for the at least one vapor barrier layer of at least about 0.05 cm and optimizing one or more of the porosity, the tortuosity, and the thickness of the vapor barrier layer to produce the desired MTC in the vapor barrier layer.

### CROSS-REFERENCE TO RELATED APPLICATIONS

This application claims priority from U.S. Provisional Patent Application Ser. No. 60/737,261 filed Nov. 16, 2005, the entire disclosure of which is hereby incorporated by reference.

### BACKGROUND OF THE INVENTION

The present invention relates to electrochemical conversion cells, commonly referred to as fuel cells, which produce electrical energy by processing first and second reactants. For example, electrical energy can be generated in a fuel cell through the reduction of an oxygen-containing gas and the oxidation of a hydrogenous gas. By way of illustration and not limitation, a typical cell comprises a membrane electrode assembly (MEA) positioned between a pair of flowfields accommodating respective ones of the reactants. More specifically, a cathode flowfield plate and an anode flowfield plate can be positioned on opposite sides of the MEA. The voltage provided by a single cell unit is typically too small for useful application so it is common to arrange a plurality of cells in a conductively coupled “stack” to increase the electrical output of the electrochemical conversion assembly.

The membrane electrode assembly typically comprises a proton exchange membrane separating an anode layer and a cathode layer of the MEA. The MEA is typically characterized by enhanced proton conductivity under wet conditions. For the purpose of describing the context of the present invention, it is noted that the general configuration and operation of fuel cells and fuel cell stacks is beyond the scope of the present invention. Rather, the present invention is directed to vapor barrier layers, gas diffusion layers, and combinations of the vapor barrier layers and the gas diffusion layers incorporated in the electrochemical conversion cell. Regarding the general configuration and operation of fuel cells and fuel cell stacks, applicants refer to the vast collection of teachings covering the manner in which fuel cell “stacks” and the various components of the stack are configured. For example, a plurality of U.S. patents and published applications relate directly to fuel cell configurations and corresponding methods of operation. More specifically, FIGS. 1 and 2 of U.S. Patent Application Pub. No. 2005/0058864 and the accompanying text present a detailed illustration of the components of one type of fuel cell stack and this particular subject matter is expressly incorporated herein by reference

### SUMMARY OF THE INVENTION

In accordance with one embodiment, a method of producing an electrochemical conversion assembly comprising is provided. The electrochemical conversion assembly comprises at least one electrochemical conversion cell, which comprises a membrane electrode assembly, first and second flowfield portions defined on opposite sides of the membrane electrode assembly, and at least one vapor barrier layer disposed between the membrane electrode assembly and at least one of the flowfield portions. The method further includes selecting a desired mass transfer coefficient (MTC) for the at least one vapor barrier layer of at least about 0.05 cm, wherein the

$$MTC = \frac{D}{{D}_{eff}} h ,$$

where h is a thickness of the vapor barrier layer, D is the free gas-phase diffusivity through the vapor barrier layer, and D_{eff} is the effective diffusivity through the vapor barrier layer. The method further comprises optimizing one or more of the porosity, the tortuosity, and the thickness of the vapor barrier layer to produce the desired MTC in the vapor barrier layer.

In accordance with another embodiment, a method of producing an electrochemical conversion assembly is provided. The electrochemical conversion assembly comprises at least one electrochemical conversion cell, which comprises a membrane electrode assembly, first and second flowfield portions defined on opposite sides of the membrane electrode assembly, a gas diffusion layer between the membrane electrode assembly and the flowfield portions. The method further comprises selecting a desired mass transfer coefficient (MTC) for the gas diffusion layer of at least about 0.10 cm, wherein the

$$MTC = \frac{D}{{D}_{eff}} h ,$$

where h is a thickness of the gas diffusion layer, D is the free gas-phase diffusivity through the gas diffusion layer, and D_{eff} is the effective diffusivity through the gas diffusion layer. The method further comprises optimizing one or more of the porosity, the tortuosity, and the thickness of the gas diffusion layer to produce the desired MTC in the gas diffusion layer.

In accordance with yet another embodiment, a method of producing an electrochemical conversion assembly is provided. The electrochemical conversion assembly comprising at least one electrochemical conversion cell, which comprises a membrane electrode assembly, first and second flowfield portions defined on opposite sides of the membrane electrode assembly, respective gas diffusion layers between the membrane electrode assembly and the flowfield portions, and respective vapor barrier layers between the respective gas diffusion layers and the membrane electrode assembly. The method further comprises selecting a desired overall mass transfer coefficient (MTCₒᵥₑᵣₐₗₗ) wherein the gas diffusion layers and vapor barrier layers define an overall mass transfer coefficient (MTCₒᵥₑᵣₐₗₗ) of at least about 0.15 cm, wherein

$${MTC}_{overall} = {( \frac{{D}_{gdl}}{{D}_{gdleff}} {h}_{gdl} )}_{GDL} + {( \frac{{D}_{vbl}}{{D}_{vbleff}} {h}_{vbl} )}_{VBL} ,$$

where h_{gdl} is a thickness of the gas diffusion layer, D_{gdl} is the free gas-phase diffusivity through the gas diffusion layer, D_{gdleff} is the effective diffusivity through the gas diffusion layer, h_{vbl} is a thickness of the vapor barrier layer, D_{gdl} is the free gas-phase diffusivity through the vapor barrier layer, D_{vbleff} is the effective diffusivity through the vapor barrier layer. The method further comprises optimizing one or more of the porosity, the tortuosity, and the thickness of the gas diffusion layer, the vapor barrier layer, or both, to produce the desired MTCₒᵥₑᵣₐₗₗ in the gas diffusion layer.

Additional features and advantages provided by the methods of the present invention will be more fully understood in view of the following detailed description, in conjunction with the drawings.

### BRIEF DESCRIPTION OF THE DRAWINGS

The following detailed description of the illustrative embodiments of the present invention can be best understood when read in conjunction with the following drawings, where like structure is indicated with like reference numerals and in which:

FIG. 1 is a schematic illustration of an electrochemical conversion cell according to one or more embodiments of the present invention; and

FIG. 2 is a graphical illustration of the high frequency resistance of the membrane electrode assembly at various times and temperatures according to one or more embodiments of the present invention.

FIG. 3 is a graphical illustration comparing the adjusted high frequency resistances of fuel cells according to one or more embodiments of the present invention.

### DETAILED DESCRIPTION

The durability of a fuel cell utilizing a hydrated MEA strongly depends on the hydration status of the polymer electrolyte membrane used in the MEA. To reduce the resistance of proton conductivity in the membrane, it is normally desired to keep the polymer electrolyte membrane sufficiently hydrated. Under typical operating conditions the MEA cycles through relatively wet and relatively dry states. These membrane hydration cycles are particularly prevalent during fuel cell start-up and shut-down operations and as power demand fluctuates during operation of the fuel cell.

One of the consequences of the aforementioned hydration cycling is significant degradation of the mechanical durability of the MEA. More specifically, the fatigue cycle life of a MEA is directly related to membrane stress, where higher membrane stress can result in lower fatigue cycle life of MEA. In turn, membrane stress is a strong function of water content change from hydration to dehydration states and hydration/dehydration rates. Consequently, the present invention is directed to improved ways of controlling water migration in a fuel cell to reduce membrane degradation.

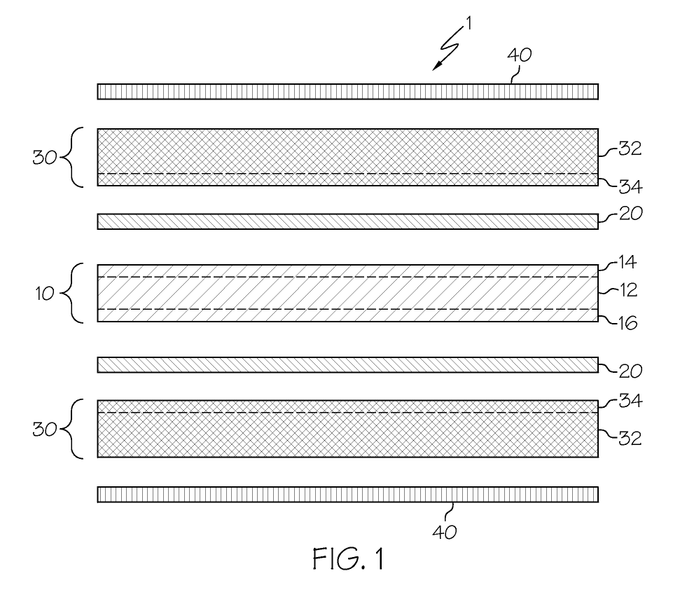

Referring to an invention embodiment as shown in FIG. 1, an electrochemical conversion cell 1 is provided. The cell 1 comprises a membrane electrode assembly 10, which comprises a membrane 12 as well as anode 14 and cathode 16 electrodes disposed on opposite sides of the membrane 12. The cell 1 also comprises first and second flowfield portions 40 defined on opposite sides of the membrane electrode assembly 10. In one embodiment, the cell 1 comprises at least one vapor barrier layer 20 disposed between the membrane electrode assembly 10 and at least one of the flowfield portions 40. In another embodiment, the cell 1 comprises at least one gas diffusion layer 30 disposed on opposite sides of the membrane electrode assembly 10. In a specific embodiment, the gas diffusion layer 30 comprises a substrate 32 and a microporous layer 34 disposed thereon. Referring to yet another embodiment as shown in FIG. 1, the cell 1 may comprise both vapor barrier layers 20 and gas diffusion layers 30. It is contemplated that the vapor barrier layer 20 may envelope the MEA, be attached to the MEA, be formed integrally with the MEA, be attached to the gas diffusion media so as to abut the MEA, or be sandwiched between the gas diffusion media and the MEA. In a few exemplary embodiments, the vapor barrier layer 20 is adhesively bonded or hot pressed to the membrane electrode assembly 10. When constructing the electrochemical conversion cell 1, provision should be made to minimize electrical contact resistance between the vapor barrier layer 20, the MEA 10, and the gas diffusion layer 30, regardless of how the vapor barrier layer 20 is incorporated into the structure of the fuel cell.

In operation, the membrane electrode assembly (MEA) 10 may be hydrated by transporting water from the humidified gas stream in the reactant gas channels of the flow field 40. In addition, the MEA 10 may be humidified by the water generated at the cathode electrode 16. When the reactant gas flow has lower humidity than the MEA 10, water may be transported from the MEA 10, through the gas diffusion layer 30, to the gas channels, resulting in the dehydration of the membrane 10. To reduce the membrane stress and to increase the MEA life, it is desired to reduce the change of water content in membrane from hydration to dehydration states and/or reduce the dehydration rate by controlling the mass transfer coefficient of the materials between MEA and reactant gas channels. Specifically, the present invention is directed to controlling the mass transfer coefficient of the vapor barrier layer 20, the gas diffusion layer 30, or both.

The mass transfer coefficient (MTC) is defined by the following equation:

$$MTC = \frac{D}{{D}_{eff}} h$$

where h is the thickness of the gas diffusion layer or vapor barrier layer; D is the free gas-phase diffusivity; and D_{eff} is the effective diffusivity in the gas diffusion layer or vapor barrier layer. As the MTC increases, the rate of vapor transport decreases, which results in slower hydration change in the membrane as the fuel cell operation conditions changes. The ratio of D/D_{eff} is considered to be a material property, which is a function of the porosity and tortuosity of the vapor barrier layer or gas diffusion layer, and should be consistent with different gases. It should be noted that the physics which governs the MTC is the diffusion of water vapor through the vapor barrier layer or gas diffusion layer, which is driven by the concentration gradient of the water vapor through the thickness of the vapor barrier layer or the gas diffusion layer. It should be further noted that the diffusion property is essentially different from the permeability. In the physics of permeation, water can be transported through the vapor barrier layer by convection which is driven by the pressure gradient through the thickness of the vapor barrier layer or gas diffusion layer. Since in fuel cells, the pressure gradient from the gas flow channels to the MEA 10 is very low, the water transport should be governed by the diffusion of water vapor, which is directly related to the MTC defined in this invention. In fuel cell study, oxygen transport is commonly used to obtain D/D_{eff}. As would be familiar to one of ordinary skill in the art, free oxygen diffusivity, D₀₂, can be easily calculated with known gas composition [Wilke, C. R. 1950. Chemical Engineering Progress 46:95-104]. On the other hand, effective oxygen diffusivity, D_{eff,02}, can only be obtained from experiment. Limiting current method is the most common experimental test to determine effective oxygen diffusivity and can be written as:

$${D}_{eff} = \frac{{i}_{lim}}{4 F} \times \frac{h}{{C}_{{O}_{2}}}$$

where F is the Faraday constant; h is the thickness of the gas diffusive layer; iₗᵢₘ is the limiting current; and C₀₂ is the oxygen concentration in the flowfield. The limiting current method could be done in a fuel cell with 5 cm² active area and high stoichiometry to provide uniform cell oxygen concentration. Limiting current can then be measured when a cell is operating at low voltage, e.g. 0.1V.

According to one embodiment of the present invention, the MTC of the vapor barrier layer 20 defines a value of at least about 0.05 cm. This desired MTC value is obtained by optimizing the porosity of the vapor barrier layer 20, the tortuosity of the vapor barrier layer 20, the thickness of the vapor barrier layer 20, or combinations thereof. As used herein, “optimizing” means raising or lowering the porosity, tortuosity, thickness, or combinations thereof. In addition to achieving the desired MTC, minimizing the thickness of the vapor barrier layer 20 may reduce the electrical resistance of the vapor barrier layer 20. Tortuosity is defined as the square of the ratio of the effective length of pore channels to the length parallel to the overall direction of the pore channels in a porous medium. Tortuosity can be determined experimentally by using different techniques, such as conductivity and diffusion techniques, ion transit-time techniques and pore-distribution techniques, as would be familiar to one of ordinary skill in the art.

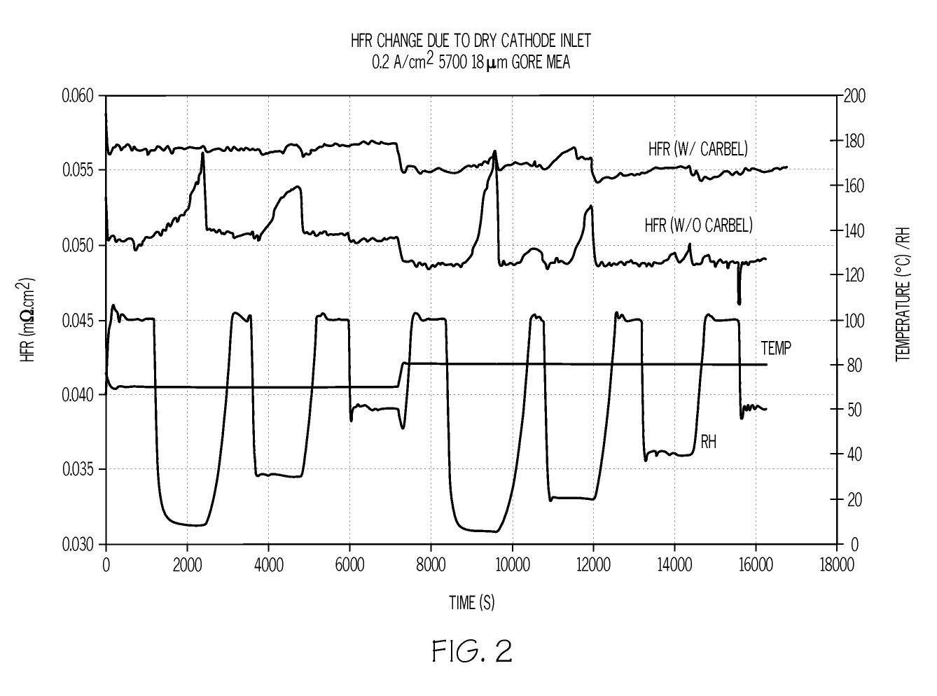

The materials of the vapor barrier layer 20 are also carefully selected to ensure that an MTC of at least 0.05 cm is achieved. These materials may include metal, carbon based materials, or combinations thereof. In one embodiment, the vapor barrier layer 20 comprises carbon fibers, sheets, or combinations thereof. One suitable material may be Carbel™ MP30Z gas diffusion media, available from WL Gore and Associates, Inc, with its thickness and porosity optimized to achieve the desired MTC. For example, referring to FIG. 2, where the high frequency resistance (HFR) of a conventional MEA and a Carbel™ enhanced MEA are plotted over time, test results show that, at a current density of 0.2 A/cm², the change in membrane HFR is dramatically reduced when the Carbel™ vapor barrier layer is utilized. Since the HFR is correlated to the membrane hydration or water content, the higher HFR fluctuation would indicate a higher degree of hydration change at a higher dehydration rate. As a result, the MEA enhanced with the Carbel™ vapor barrier layer is expected to be significantly less prone to pinhole formation and crossover leakage in the fuel cell stack. Alternative materials operable to produce the desired MTC values include graphite flakes, metal foil with holes, and carbon fiber or particles layered with filling content to adjust e.g. reduce porosity. Typical filling content includes fluoropolymer, like PTFE or FEP, carbon particles, carbonizable thermoset resin, ionomers, etc. The vapor barrier layer 20 may comprise various thicknesses, as long as the thickness does not reduce the MTC to below about 0.05 cm. In one embodiment, the vapor barrier layer 20 may comprise thicknesses of up to 100 μm. 3. In further embodiments, the optimized vapor barrier layer 20 may comprises a porosity of between about 20% to about 70%, and a tortuosity of between about 4 to about 10.

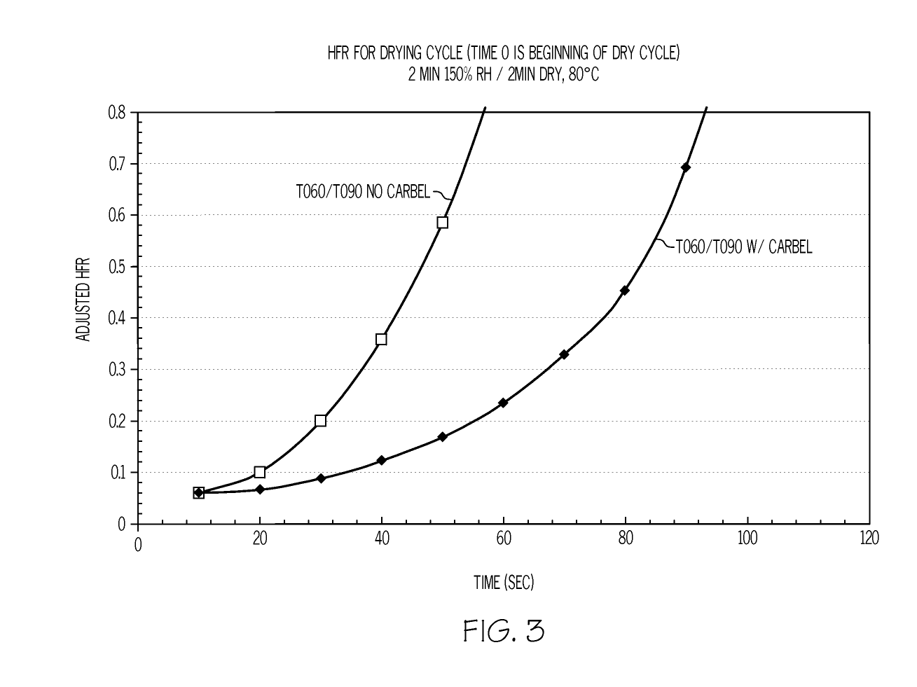

As shown in FIG. 3, the vapor barrier layer 20 at the desired MTC defines an adjusted High Frequency Resistance (HFR) at least 50% less than a vapor barrier layer defining an MTC below 0.05 cm. HFR is measured by a method called AC Impedance Spectroscopy, and is typically performed at 1 k Hz frequency. The adjusted high frequency resistance in the presence of vapor barrier layer is determined by subtracting the bulk resistance of the vapor barrier layer, the contact resistances between the MEA and the vapor barrier layer, and the contact resistance between the gas diffusion layer and the vapor barrier layer from the measured HFR. The bulk resistance of the vapor barrier layer, the contact resistances between the MEA and the vapor barrier layer, and the contact resistance between the gas diffusion layer and the vapor barrier layer are essentially constant despite the change in the conductivity in the membrane. HFR, along with adjusted HFR, is an indication of the ohmic resistance in the fuel cell. In accordance with the present invention, the change in HFR is an indication of the change of proton resistance in the MEA, which in turn provides an indication of the hydration change in the membrane. The faster the HFR change would indicate faster hydration or dehydration of an MEA. By lowering the HFR through control of the MTC, the cell 1 is subjected to less dehydration states, thereby cell life is increased and membrane stresses are reduced.

In the embodiment utilizing a gas diffusion layer 30, the MTC is maintained at least above 0.10 cm. As shown in the embodiment of FIG. 1, the gas diffusion layer 30 may comprise multiple layers, for example, a substrate 32, and a microporous layer attached thereon. The substrate 32 comprises various materials known to one of ordinary skill in the art. In one embodiment, the gas diffusion layer 30 may comprise carbon paper, carbon fibers, fluoropolymers, and combinations thereof. Referring to the embodiment of FIG. 1, the substrate 32 may comprise a carbon based material, and the microporous layer may comprise a fluoropolymer. Various thicknesses are also contemplated, for example, the gas diffusion layer 30 may comprise a thickness of between about 150 μm to about 250 μm. In further embodiments, the optimized gas diffusion layer 30 may comprises a porosity of between about 20% to about 70%, and a tortuosity of between about 4 to about 10. In a couple exemplary embodiments, gas diffusion layers 30 may comprise SGL25BC® produced by SGL Carbon Group) at a thickness of 230 μm or Toray TGP-H-060® produced by Toray Industries, Inc at a thickness of 190 μm.

Referring to the embodiment of FIG. 1, which comprises vapor barrier layers and gas diffusion layers, the cell 1 comprises a mass transfer coefficient (MTCₒᵥₑᵣₐₗₗ) of at least about 0.15 cm, as defined by the gas diffusion layers and vapor barrier layers. The MTCₒᵥₑᵣₐₗₗ is defined below

$${MTC}_{overall} = {( \frac{{D}_{gdl}}{{D}_{gdleff}} {h}_{gdl} )}_{GDL} + {( \frac{{D}_{vbl}}{{D}_{vbleff}} {h}_{vbl} )}_{VBL}$$

where h_{gdl} is a thickness of the gas diffusion layer, D_{gdl} is the free gas-phase diffusivity through the gas diffusion layer, D_{gdleff} is the effective diffusivity through the gas diffusion layer, h_{vbl} is a thickness of the vapor barrier layer, D_{vbl} is the free gas-phase diffusivity through the vapor barrier layer, D_{vbleff} is the effective diffusivity through the vapor barrier layer. To achieve an MTCₒᵥₑᵣₐₗₗ above 0.15 cm, on or more of the properties i.e. porosity, thickness, tortuosity, of the gas diffusion layer, the vapor barrier layer, or both, may be adjusted.

The above embodiments may reduce the crossover leaks in fuel cell stacks and increase the cell life. Cell life can be improved significantly if a vapor barrier layer is provided in the cell structure in such a way as to keep the membrane of the MEA at a more constant hydration state, even where the operating conditions of the fuel cell would otherwise dictate significant fluctuation of membrane hydration. In doing so, it is contemplated that stack durability can be enhanced by mitigating membrane hydration fluctuations, a significant source of pinhole formation and crossover leaks in fuel cell stacks.

To demonstrate the benefits of the vapor barrier layer, relative humidity cycling tests were conducted to evaluate the fatigue life of the MEA with and without Carbel™ MP30Z. In both tests, the gas diffusion layers comprise the Toray TGP-H-060® and Toray TGP-H-060® on the anode and cathode sides of the MEA, respectively. The RH cycling tests were conducted by intermittently flowing wet and dry inert gases over the membrane in a non-operating fuel cell. Membrane electrode assemblies with anode and cathode platinum loadings of 0.5 mg/mc² were built in 50 cm² cells using flow fields with 2 mm wide straight channels separated by 2 mm wide lands. The membrane electrode assemblies were compressed between two pieces of commercially available carbon fiber gas diffusion media. The cycle consisted of flowing 2.0 standard liters per minute (SLPM) of 0% relative humidity (RH) air over both the anode and cathode sides of the membrane electrode assembly for two minutes followed by flowing 2.0 SLPM of super-saturated wet air over both sides of the cell for two minutes. The tests ran isothermically at 80° C. with no backpressure. To ensure that any failures that occurred were induced solely by mechanical stresses, no hydrogen gas was used and no current was drawn from the cell during the test. Membrane failure was determined by periodically measuring the flow of air across the membrane with a 3 psi pressure applied to one side of the cell. FIG. 3 illustrates the adjusted HFR during the drying cycle. It is clearly seen that the cell with the vapor barrier layer, has much slower rate in the change of HFR, which induces lower membrane stress. As a result, the cell with the vapor barrier layer has 80% longer life before reaching 10 SCCM (standard cubic centimeters per minute) of gas crossover leakage. In both examples cited above, the gas diffusion layer has a MTC value of 0.11 cm, and the vapor barrier layer has an MTC of 0.05 cm, thereby producing a total MTC of 0.16 cm.

Regarding the general configuration and operation of fuel cells and fuel cell stacks, applicants refer to the vast collection of teachings covering the manner in which fuel cell “stacks” and the various components of the stack are configured. For example, a plurality of U.S. patents and published applications relate directly to fuel cell configurations and corresponding methods of operation. More specifically, FIGS. 1 and 2 of U.S. Patent Application Pub. No. 2005/0058864, and the accompanying text, present a detailed illustration of the components of a fuel cell stack. Further, U.S. Pat. App. Pub. Nos. 2004/0137299 and 2004/0229100 also present detailed descriptions of the structure of a fuel cell stack. The respective disclosures of these publications are incorporated herein by reference, to the extent they relate to the general structure of a fuel cell stack.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue. It is further noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of producing an electrochemical conversion assembly comprising:
providing an electrochemical conversion assembly comprising at least one electrochemical conversion cell, the electrochemical conversion cell comprising a membrane electrode assembly, first and second flowfield portions defined on opposite sides of the membrane electrode assembly, and at least one vapor barrier layer disposed between the membrane electrode assembly and at least one of the flowfield portions;
selecting a desired mass transfer coefficient (MTC) for the at least one vapor barrier layer of at least about 0.05 cm, wherein the
$$MTC = \frac{D}{{D}_{eff}} h ,$$
where h is a thickness of the vapor barrier layer, D is the free gas-phase diffusivity through the vapor barrier layer, and D_{eff} is the effective diffusivity through the vapor barrier layer; and
optimizing one or more of the porosity, the tortuosity, and the thickness of the vapor barrier layer to produce the desired MTC in the vapor barrier layer.

2. A method according to claim 1 wherein the optimized vapor barrier layer comprises a thickness of up to 100 μm.

3. A method according to claim 1 wherein the optimized vapor barrier layer comprises a porosity of between about 20% to about 70%.

4. A method according to claim 1 wherein the optimized vapor barrier layer comprises a tortuosity of between about 4 to about 10.

5. A method according to claim 1 further comprising adhesively bonding the vapor barrier layer to the membrane electrode assembly in order to reduce electrical resistance across an interface therebetween.

6. A method according to claim 1 further comprising hot pressing the vapor barrier layer to the membrane electrode assembly in order to reduce electrical resistance across an interface therebetween.

7. A method according to claim 1 wherein the vapor barrier layer comprises metal, or graphite.

8. A method according to claim 1 wherein the vapor barrier layer comprises carbon fibers, carbon sheets, or combinations thereof

9. A method according to claim 1 wherein the vapor barrier layer comprises filler material comprising fluoropolymers, carbon particles, carbonizable thermoset resin, ionomers, or combinations thereof.

10. A method of producing an electrochemical conversion assembly comprising:
providing an electrochemical conversion assembly comprising at least one electrochemical conversion cell, the electrochemical conversion cell comprising a membrane electrode assembly, first and second flowfield portions defined on opposite sides of the membrane electrode assembly, and a gas diffusion layer between the membrane electrode assembly and the flowfield portions;
selecting a desired mass transfer coefficient (MTC) for the gas diffusion layer of at least about 0.10 cm, wherein the
$$MTC = \frac{D}{{D}_{eff}} h ,$$
where h is a thickness of the gas diffusion layer, D is the free gas-phase diffusivity through the gas diffusion layer, and D_{eff} is the effective diffusivity through the gas diffusion layer; and
optimizing one or more of the porosity, the tortuosity, and the thickness of the gas diffusion layer to produce the desired MTC in the gas diffusion layer.

11. A method according to claim 10 wherein the gas diffusion layer comprises a substrate layer and a microporous layer arranged thereon.

12. A method according to claim 10 wherein the gas diffusion layer comprises carbon paper, carbon fibers, fluoropolymers, and combinations thereof.

13. A method according to claim 10 wherein the optimized gas diffusion layer comprises a thickness of between about 150 μm to about 250 μm.

14. A method according to claim 10 wherein the optimized gas diffusion layer comprises a porosity of between about 20% to about 70%.

15. A method according to claim 10 wherein the optimized gas diffusion layer comprises a porosity of between about 4 to about 10.

16. A method of producing an electrochemical conversion assembly comprising:
providing an electrochemical conversion assembly comprising at least one electrochemical conversion cell, the electrochemical conversion cell comprising a membrane electrode assembly, first and second flowfield portions defined on opposite sides of the membrane electrode assembly, respective gas diffusion layers between the membrane electrode assembly and the flowfield portions on opposite sides of the membrane electrode assembly, and respective vapor barrier layers between the respective gas diffusion layers and the membrane electrode assembly;
selecting a desired overall mass transfer coefficient (MTCₒᵥₑᵣₐₗₗ) wherein the gas diffusion layers and vapor barrier layers define an overall mass transfer coefficient (MTCₒᵥₑᵣₐₗₗ) of at least about 0.15 cm, wherein
$${MTC}_{overall} = {( \frac{{D}_{gdl}}{{D}_{gdleff}} {h}_{gdl} )}_{GDL} + {( \frac{{D}_{vbl}}{{D}_{vbleff}} {h}_{vbl} )}_{VBL} ,$$
where h_{gdl} is a thickness of the gas diffusion layer, D_{gdl} is the free gas-phase diffusivity through the gas diffusion layer, D_{gdleff} is the effective diffusivity through the gas diffusion layer, h_{vbl} is a thickness of the vapor barrier layer, D_{vbl} is the free gas-phase diffusivity through the vapor barrier layer, D_{vbleff} is the effective diffusivity through the vapor barrier layer; and
optimizing one or more of the porosity, the tortuosity, and the thickness of the gas diffusion layer, the vapor barrier layer, or both, to produce the desired MTCₒᵥₑᵣₐₗₗ.
